(19) United States
(12) Patent Application Publication
(10) Pub. No.: US 2023/0041825 A1
(43) Pub. Date: Feb. 9, 2023

(54) DEVICE AND COMPUTER-IMPLEMENTED METHOD FOR DETERMINING A VARIABLE OF A TECHNICAL SYSTEM

(71) Applicant: Robert Bosch GmbH, Stuttgart (DE)

(72) Inventors: Barbara Rakitsch, Stuttgart (DE); Volker Imhof, Kornwestheim (DE); Gonca Guersun, Stuttgart (DE); Patrick Engel, Leonberg (DE); Sebastian Gerwinn, Leonberg (DE)

(21) Appl. No.: 17/813,074

(22) Filed: Jul. 18, 2022

(30) Foreign Application Priority Data
Jul. 21, 2021 (DE) 10 2021 207 798.6

(51) Int. Cl. G05B 13/04; G01M 15/04

(52) U.S. Cl. CPC G05B 13/041; G05B 13/047; G01M 15/04

(57) ABSTRACT

A device, computer program, and computer-implemented method for determining a variable of a technical system. An input variable is determined for a first model for determining the variable at a first temporal resolution. A first time series is provided, at the first temporal resolution, including values which characterize an operating variable of the technical system. A second time series is provided. at a second temporal resolution, including values which characterize the operating variable of the technical system, the first and second temporal resolutions being different. The second time series is mapped using a second model for determining a first prediction for the variable of the technical system at the second temporal resolution on the first prediction. Parameters of a second model are determined, using the second time series, which are mapped on parameters of a third model at the first temporal resolution.

### CROSS REFERENCE

The present application claims the benefit under 35 U.S.C. § 119 of German Patent Application No. DE 10 2021 207 798.6 filed on Jul. 21, 2021, which is expressly incorporated herein by reference in its entirety.

### FIELD

The present invention relates to a device and a computer-implemented method for determining a variable of a technical system.

### BACKGROUND INFORMATION

Variables of a technical system may be predicted by state space models based on operating variables of the technical system. Depending on the resolution of the data used, state space models take into consideration either long-term effects or short-term effects.

### SUMMARY

Using the computer-implemented method and the device and also the computer program in accordance with the present invention, it is possible to take into consideration both long-term effects and short-term effects.

In accordance with an example embodiment of the present invention, the computer-implemented method for determining a variable of a technical system, in particular a fuel cell or an internal combustion engine, provides that an input variable for a first model for determining the variable is determined at a first temporal resolution, a first time series being provided at the first temporal resolution, the first time series including values which characterize an operating variable of the technical system, a second time series being provided at a second temporal resolution, the second time series including values which characterize the operating variable of the technical system, the first temporal resolution being different from the second temporal resolution, the second time series being mapped on the first prediction using a second model for determining a first prediction for the variable of the technical system at the second temporal resolution, parameters of a second model being determined using the second time series, the parameters of the second model being mapped on parameters of a third model at the first temporal resolution, the first time series being mapped using the third model on a second prediction at the first temporal resolution, the input variable including at least a part of the first time series and at least a part of the second prediction, parameters of the first model being determined using the input variable, and the input variable being mapped using the first model on the variable. Multiple models having different resolutions are thus trained and a prediction for the variable is formed which takes into consideration both long-term effects and short-term effects.

In accordance with an example embodiment of the present invention, it may be provided that the technical system is the internal combustion engine, the operating variable characterizing a velocity or a load of the internal combustion engine and/or the variable characterizing a hydrocarbon emission, a nitrogen oxide emission, a temperature, a particle emission, or an oxygen content of the internal combustion engine.

In accordance with an example embodiment of the present invention, it may be provided that the technical system is the fuel cell, the operating variable characterizing a current in a fuel cell stack of the fuel cell, a hydrogen concentration in the fuel cell or a stoichiometry of the anode or a stoichiometry of the cathode or a coolant volume flow or an anode pressure or a cathode pressure or a temperature of a coolant inflow or a temperature of an anode dewpoint or a temperature of a cathode dewpoint of the fuel cell and/or the variable characterizing an average cell voltage, an anode pressure drop, a cathode pressure drop, a coolant pressure drop, or an increase of a coolant temperature.

The second time series preferably includes values from the first time series which are taken from the first time series at the second resolution. A reduction of the resolution is thus implemented particularly efficiently.

The second time series preferably includes values of a third prediction for the variable of the technical system, the third prediction being determined using a fourth model as a function of a third time series, which includes values of the operating variable in a third resolution, which is different from the first resolution and the second resolution. A multilayer model is thus trained and used to predict the variable.

The parameters of the second model are preferably determined in a training of the second model using training data which include the second time series and a reference for the first prediction at the second resolution. The parameters of the first model are preferably determined in a training of the first model using training data which include the input variable and a reference for the variable at the first resolution. The long-term effects are thus particularly effectively learned in the second model and the short-term effects are particularly effectively learned in the first model.

In accordance with an example embodiment of the present invention, it may be provided that the third model includes a first linear transition model, in which a first matrix for mapping a state variable of the first linear transition model is determined by at least a part of the parameters of the third model, the second model including a second linear transition model, in which a first matrix for mapping a state variable of the second linear transition model is determined by at least a part of the parameters of the second model, the first matrix of the first transition model being determined as a function of a root of the first matrix of the second transition model, an order of the root being determined as a function of a ratio of the first resolution to the second resolution. A part of a third model upscaled in relation to the second model is thus determined, using which the second prediction is determinable.

In accordance with an example embodiment of the present invention, it may be provided that the first linear transition model includes a second matrix for mapping the first time series, the second matrix being determined by at least a part of the parameters of the third model, the second linear transition model including a second matrix for mapping the second time series, the second matrix being determined by at least a part of the parameters of the second model, the second matrix of the first transition model being determined as a function of a product of an inverse of a sum of a number of summands with the second matrix of the second transition model, the sum of each summand including a power of the first matrix of the first transition model, the number of summands being determined as a function of a ratio of the first resolution to the second resolution, the powers of order different from one another being from a set of integer numbers from 1 to the number. A further part of the upscaled third model is thus determined, using which the second prediction is determinable.

In accordance with an example embodiment of the present invention, it may be provided that the third model includes an additive disturbance variable for the state variable of the first linear transition model, the disturbance variable of the third model being determined by a covariance matrix of a distribution, in particular a Gaussian distribution, the second model including an additive disturbance variable for the state variable of the second linear transition model, the disturbance variable of the second model being determined by a covariance matrix of a distribution, in particular a Gaussian distribution, the covariance matrix of the third model being determined in such a way that the distance between the covariance matrix of the second model and a sum of a number of summands is minimal, the sum of each summand including a product of a power of the first matrix of the third model with the covariance matrix of the third model and with a transpose of the power of the first matrix, the number of summands being determined as a function of a ratio of the first resolution to the second resolution, the powers of order different from one another being from a set of integer numbers from 1 to the number.

Preferably, the variable is determined for a time series which represents the operating variable of the technical system in the first temporal resolution, if the variable meets one condition, an anomaly being recognized and/or the technical system being switched into a safe operating state, or the technical system otherwise being switched into an intended operating state.

In accordance with an example embodiment of the present invention, a device for determining the variable of the technical system includes a computing unit which is designed to carry out steps in the method.

In accordance with an example embodiment of the present invention, the computer program includes computer-readable instructions, upon the execution of which by a computer, steps in the method are carried out.

Further advantageous specific embodiments result from the following description and the figures.

### BRIEF DESCRIPTION OF THE DRAWINGS

FIG. 1 shows a schematic representation of at least a part of a device for determining a variable of a technical system, in accordance with an example embodiment of the present invention.

FIG. 2 shows a schematic representation of a training of a model for determining the variable, in accordance with an example embodiment of the present invention.

FIG. 3 shows steps in a method for determining the variable of the technical system, in accordance with an example embodiment of the present invention.

### DETAILED DESCRIPTION OF EXAMPLE EMBODIMENTS

At least a part of a device 100 for determining a variable of a technical system 102 is schematically shown in FIG. 1.

Technical system 102 is either a fuel cell or an internal combustion engine in the example. Technical system 102 may be a computer-controlled or computer-regulated machine, e.g., a robot, a vehicle, a household appliance, a machine tool, a manufacturing machine, a personal assistance system, or an access control system.

Device 100 includes a computing unit, which is designed to carry out a method described hereinafter. The computing unit in the example includes at least one processor 104 and at least one memory 106. Device 100 in the example includes an input 108, which is designed to receive an operating variable of technical system 102. In the example, the device is designed to determine the variable as a function of the operating variable. Device 100 in the example includes an output 110, which is designed to output the variable. Device 100 may be a sensor for or an observer of technical system 102.

The operating variable may be a sensor signal, for example, a video, radar, LIDAR, or ultrasonic sensor signal or a signal of a motion sensor. The operating variable may be a variable of a network node in a 5G network.

The at least one processor 104, the at least one memory 106 of input 108, and output 110 are connected, for example, to a data link 112 for communication. Input 108 and technical system 102 are connected in the example via a first line 114 to transmit the operating variable. Output 110 is connected in the example to a second line 116 to transmit the variable.

The operating variable and the variable may additionally or alternatively also be stored in memory 106, in particular if a training or a modeling of the variable using data sets of already detected operating variables is provided.

Device 100 may be designed to classify the operating variable, in particular the sensor signal, and to operate technical system 102 as a function of a result of the classification.

Device 100 may be designed to classify the operating variable, in particular the sensor signal, in order to discover an anomaly therein, and to transfer technical system 102 into a safe state if an anomaly is recognized and otherwise to continue to operate technical system 102.

If technical system 102 is the internal combustion engine, it may be provided that the operating variable characterizes a velocity or a load of the internal combustion engine.

If technical system 102 is the internal combustion engine, it may be provided that the variable characterizes a hydrocarbon emission, a nitrogen oxide emission, a temperature, a particle emission, or an oxygen content of the internal combustion engine.

If technical system 102 is the fuel cell, it may be provided that the operating variable characterizes a current in a fuel cell stack of the fuel cell, a hydrogen concentration in the fuel cell, or a stoichiometry of the anode or a stoichiometry of the cathode or a coolant volume flow or an anode pressure or a cathode pressure or a temperature of a coolant inflow or a temperature of an anode dewpoint or a temperature of a cathode dewpoint of the fuel cell.

If technical system 102 is the fuel cell, it may be provided that the variable characterizes an average cell voltage, an anode pressure drop, a cathode pressure drop, a coolant pressure drop, or an increase of a coolant temperature.

The computing unit includes, for example, a computer on which a computer program runs, which is preferably stored in the at least one memory 106. In the example, the computer program includes computer-readable instructions, upon the execution of which by the computer, the method is carried out.

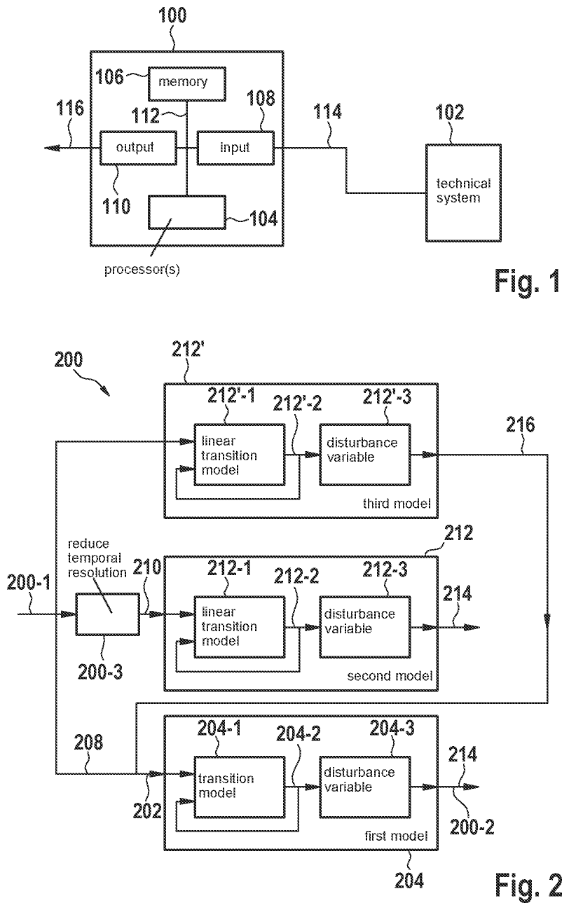

A model 200 is schematically shown in FIG. 2, using which an input variable 202 of a first model 204 for determining a variable 206 is mappable on variable 206. In the example, variable 206 is the variable of technical system 102.

Model 200 includes an input 200-1 for a first time series 208 at a first temporal resolution. Model 200 includes an output 200-2 for variable 206.

In the example, first time series 208 includes values which characterize the operating variable of technical system 102.

Model 200 includes a unit 200-3 for reducing a temporal resolution, which is designed to determine a second time series 210 at a second temporal resolution. Second time series 210 includes values which characterize the operating variable of technical system 102.

In the example, unit 200-3 for reducing the temporal resolution is designed to take values from first time series 208 at the second resolution.

Unit 200-3 for reducing the temporal resolution may also be designed to determine second time series 208 by way of a different sampling method at a resolution reduced in relation to the first temporal resolution. The first resolution is different from the second resolution. In the example, the first temporal resolution is 0.1 seconds and the second resolution is 1 second.

Model 200 includes a second model 212 for determining a first prediction 214 for variable 206 at the second temporal resolution. Second time series 210 is mappable using second model 212 on first prediction 214.

Model 200 includes a third model 212′ for determining a second prediction 216 for variable 206 at the first temporal resolution. First time series 208 is mappable using third model 212′ on second prediction 216.

In the example, input variable 202 includes first time series 208 and second prediction 216. It may also be provided that input variable 202 includes a part of first time series 208 and a part of second prediction 216.

First model 204 is determined by parameters of first model 204. Second model 212 is determined by parameters of second model 212.

First model 204 includes a transition model 204-1:

xₜ=Axₜ₋₁+Cuₜ+εₜ

x representing a state variable 204-2 of transition model 204-1 and u representing input variable 202, a first matrix A for mapping state variable 204-2 of transition model 204-1 being determined by at least a part of the parameters of first model 204, a second matrix C for mapping input variable 202 being determined by at least a part of the parameters of first model 204, and εₜ representing an additive disturbance variable 204-3 for state variable 204-2 of transition model 204-1. Disturbance variable 204-3 of first model 204 is determined in the example by a covariance matrix of a distribution, in particular a Gaussian distribution, for example as:

εₜ˜ [symbol] (m,Σ)

in the example, [symbol] (m, Σ) being a Gaussian distribution including mean value m and covariance matrix Σ. The mean value is, for example, m=0.

Second model 212 includes a linear transition model 212-1:

xₜ⁽¹⁾=Ã⁽¹⁾xₜ₋₁⁽¹⁾+\tilde{C}⁽¹⁾uₜ⁽¹⁾+\tilde{ε}⁽¹⁾ₜ

x^{(t)} representing a state variable 212-2 of linear transition model 212-1 and u⁽¹⁾ representing second time series 210, a first matrix Ã⁽¹⁾ for mapping state variable 212-2 of linear transition model 212-1 being determined by at least a part of the parameters of second model 212, a second matrix \tilde{C}⁽¹⁾ for mapping second time series 210 being determined by at least a part of the parameters of second model 212, and \tilde{ε}⁽¹⁾ₜ representing an additive disturbance variable 212-3 for state variable 212-2 of linear transition model 212-1. Disturbance variable 212-3 of second model 212 is determined in the example by a covariance matrix of a distribution, in particular a Gaussian distribution, for example as:

\tilde{ε}ₜ⁽¹⁾˜ [symbol] (\tilde{m}⁽¹⁾,\tilde{Σ}⁽¹⁾)

in the example, [symbol] (\tilde{m}⁽¹⁾, \tilde{Σ}⁽¹⁾) being a Gaussian distribution having mean value \tilde{m}⁽¹⁾ and covariance matrix \tilde{Σ}⁽¹⁾. The mean value is, for example, \tilde{m}⁽¹⁾=0.

Third model 212′ includes a linear transition model 212′-1:

xₜ=A⁽¹⁾xₜ₋₁+C⁽¹⁾uₜ+∈ₜ

x representing a state variable 212′-2 of linear transition model 212′-1 and u representing first time series 208, a first matrix A⁽¹⁾ for mapping state variable 212′-2 of linear transition model 212′-1 being determined by at least a part of the parameters of third model 212′, a second matrix C⁽¹⁾ for mapping first time series 208 being determined by at least a part of the parameters of third model 212′, and εₜ representing an additive disturbance variable 212′-3 for state variable 212′-2 of linear transition model 212-1. Disturbance variable 212-3 of second model 212 is determined in the example by a covariance matrix of a distribution, in particular a Gaussian distribution, for example as:

∈ₜ· [symbol] (m⁽¹⁾,Σ⁽¹⁾)

in the example, [symbol] (m⁽¹⁾, Σ⁽¹⁾) being a Gaussian distribution having mean value m⁽¹⁾ and covariance matrix Σ⁽¹⁾.

Model 200 is an example of a multilayer state space model including two layers. A multilayer state space model described hereinafter includes a plurality of L layers.

In the example, the multilayer state space model includes a state space model in each layer which is trained using a different temporal resolution on a data set. The resolution of the data using which the particular state space model is trained significantly decides which effects may be learned.

If the resolution is coarse, for example, 0.1 Hz, long-term effects are learned, since an effect which dates back 100 seconds only has to be noticed over 10 time steps. However, short-term effects are not learned or are only learned inadequately using the coarse resolution.

If a finer resolution than the coarse resolution, for example, 10 Hz, is used, short-term effects are learned. However, long-term effects are not learned or are only learned inadequately using the finer resolution, since an effect which dates back 100 seconds now has to be noticed over 1000 time steps.

The multilayer state model includes multiple models including linear transition models at different resolutions. In the example, the multilayer state model includes at least one model including a linear transition model at a higher resolution in relation thereto. The linear transition models switch back-and-forth between the resolutions.

In the example, each state model includes a linear transition model of low resolution:

xₜ^{(l)}=Ã^{(l)}xₜ₋₁^{(l)}+\tilde{C}^{(l)}uₜ^{(l)}+\tilde{ε}(l)ₜ

A linear transition model of higher resolution in relation thereto is associated therewith:

xₜ=A^{(l)}xₜ₋₁+C^{(l)}uₜ+εₜ

In the example, each state model includes a nonlinear emission model

y^{(l)}ₜ=g^{(l)}(x^{(l)}ₜ)

which applies for low and high resolution.

An arbitrary function class may be selected for g. In the example, g is a Gaussian process. It may also be provided that g is a neural network.

Such a linear transition model permits the stability of the dynamic model to be studied via an eigenvalue analysis or to be optimized during the training only via stable systems. This property is retained when multiple models are connected in series.

For such a linear transition model including Gaussian noise, it is possible to change between resolutions:

$$𝒩 ( {x}_{t + n} \vert {\tilde{A}}_{{x}_{t}} + {\tilde{C}}_{{u}_{i}} , \tilde{\sum } ) = \int {{\prod }^{n}}_{i = 1} 𝒩 ( {x}_{t + i} \vert {Ax}_{t + i - 1} + {C}_{{u}_{i} ,} \sum ) {dx}_{i + 1} … {x}_{t + n - 1} = 𝒩 ( {x}_{t + n} \vert {A}^{n} {x}_{t} + {\sum }_{i = 0}^{n - 1} {A}^{i} {Cu}_{t} , {\sum }_{i = 0}^{n - 1} {A}^{i} \sum {A}^{{i}^{T}} ) \\ N ( {x}_{t + n} \vert {x}_{t} + {u}_{t} , ) = \int {{\prod }^{n}}_{i = 1} N ( {x}_{t + n} \vert {A}^{( l )} {x}_{t + i - 1} + {C}^{( l )} {u}_{t} , \sum ) {dx}_{t + 1} … {x}_{t + n - 1} = N ( {x}_{t + n} \vert {A}^{( l )} {x}_{t} + {\sum }_{i = 0}^{n - 1} {A}^{{( l )}^{i}} {C}^{( l )} {u}_{t} , {\sum }_{i = 0}^{n - 1} {A}^{{( l )}^{i}} {\sum }^{( l )} {( {A}^{{( l )}^{i}} )}^{T} )$$

This relationship may be used both to increase the resolution, i.e., to change from a low to a higher resolution in relation thereto, and also to reduce the resolution, i.e., to change from a high resolution to a lower resolution in relation thereto.

Reduction of the resolution (1→n^{(l)}):

$${\tilde{A}}^{( l )} = {A}^{{( l )}^{{n}^{( l )}}} \\ {\tilde{C}}^{( l )} = {\sum }_{i = 1}^{{n}^{( l )}} {\tilde{A}}^{{( l )}^{i}} {C}^{( l )} {\tilde{\sum }}^{( l )} = {{\sum }_{i = 1}}^{{n}^{( l )}} {A}^{{( l )}^{i}} {\sum }^{( l )} {A}^{{( l )}^{{i}^{T}}}$$

The parameters of a model of higher resolution are thus convertible into the parameters of a model of lower resolution in relation thereto.

Increase of the resolution (n^{(l)}→1):

$${A}^{( l )} = \sqrt[{n}^{( l )}]{{\tilde{A}}^{( l )}} \\ {C}^{( l )} = {( {\sum }_{i = 1}^{{n}^{( l )}} {A}^{{( l )}^{i}} )}^{- 1} {\tilde{C}}^{( l )} {\sum }^{( l )} = argmin ‖ {\tilde{\sum }}^{( l )} - {\sum }_{i = 1}^{{n}^{( l )}} {A}^{{( l )}^{i}} {\sum }^{( l )} {A}^{{( l )}^{{i}^{T}}} ‖$$

The parameters of the model of lower resolution are thus convertible into the parameters of the model of higher resolution in relation thereto.

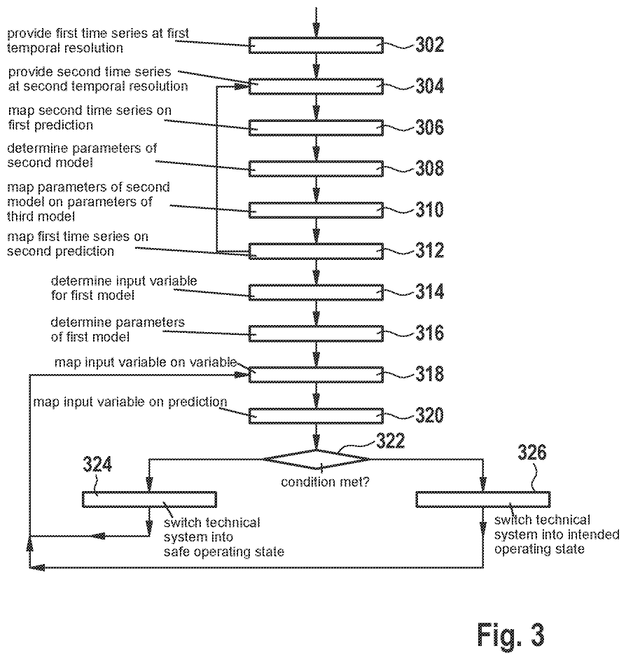

FIG. 3 schematically shows steps in the method.

In a step 302, first time series 208 is provided at the first temporal resolution.

L interleaved state space models are taught in the method using data D=(u₁:u_{T}, y₁:y_{T}) of length T, r₁, . . . , r_{L} being a resolution of the particular layer and the resolution of layer l being coarser than the resolution of layer l+1. For model 200, first time series 208 in the example is determined by (u₁:u_{T}).

In a subsequent step 304, second time series 210 is provided at the second temporal resolution.

For layer 1 of the multilayer state space model, the resolution of data D=(u₁:u_{T}, y₁:y_{T}) is reduced.

Data D=(u₁:u_{T}, y₁:y_{T}) are scaled in the example at resolution r₁, for example, in that every n₁-th data point from data D is used. The data of resolution r₁ are:

u_{1:T[n}_{₁}_{]}⁽¹⁾=(u₁,u₁₊ₙ₁, . . . , u_{T-n1},u_{T})

y_{1:T[n}_{₁}_{]}⁽¹⁾=(y₁,y₁₊ₙ_{₁}, . . . , y_{T-n}_{₁},y_{T})

For model 200, second time series 210 is determined in the example by (u₁, u₁₊ₙ₁, . . . u_{T-n1}, u_{T}).

Second time series 210 may also be an input variable for another layer l of the multilayer state space model.

In this case, second time series 210 may include values of a third prediction for the variable of technical system 102.

The third prediction is determined using a fourth model, i.e., a state space model of a layer l−1 as a function of a third time series, which includes values of the operating variable in a third resolution, which is different from the first resolution and the second resolution. The third time series may moreover, if it is not layer 1, itself include a prediction of a further layer.

In a subsequent step 306, second time series 210 is mapped using third model 212 on first prediction 214.

First prediction 214 of layer 1 is, in the example:

ŷ_{1:T[n}_{₁}_{]}⁽¹⁾=(ŷ₁⁽¹⁾, ŷ₁₊ₙ_{₁}⁽¹⁾. . . ŷ_{T-n}_{₁}⁽¹⁾,ŷ_{T}⁽¹⁾)

In a subsequent step 308, parameters of second model 212 are determined using first prediction 214.

The parameters of second model 212 are determined, for example, in a training of second model 212 using training data which include second time series 210 and a reference for first prediction 214 at the second temporal resolution.

The model of layer 1 is trained in the example on the data of resolution r₁. This means parameters A¹ and C¹ and Σ¹ of the linear transition function of layer 1:

xₜ⁽¹⁾=Ã⁽¹⁾xₜ₋₁⁽¹⁾+\tilde{C}⁽¹⁾uₜ⁽¹⁾+\tilde{ε}⁽¹⁾ₜ

and function g(⋅) of layer 1 are estimated, \tilde{ε}⁽¹⁾ₜ being determined by covariance function \tilde{Σ}⁽¹⁾ of layer 1. Parameters Ã⁽¹⁾ and \tilde{C}⁽¹⁾ and \tilde{Σ}⁽¹⁾ are parameters of second model 212 in the example.

In a subsequent step 310, parameters Ã⁽¹⁾ and \tilde{C}⁽¹⁾ and \tilde{Σ}⁽¹⁾ of second model 212 are mapped on parameters A⁽¹⁾ and C⁽¹⁾ and Σ⁽¹⁾ of third model 212′ at the first temporal resolution. This means that a resolution of parameters Ã⁽¹⁾ and \tilde{C}⁽¹⁾ and \tilde{Σ}⁽¹⁾ is increased.

After the training, the linear transition model of layer 1 is upscaled to the resolution of data D.

The resulting parameters of the upscaled linear transition model are:

$${A}^{( 1 )} = \sqrt[{n}^{( 1 )}]{{\tilde{A}}^{( 1 )}} \\ {C}^{( 1 )} = {( {\sum }_{i = 1}^{{n}^{( 1 )}} {A}^{{( l )}^{i}} )}^{- 1} {\tilde{C}}^{( 1 )} \\ {\sum }^{( 1 )} = argmin ‖ {\tilde{\sum }}^{( 1 )} - {\sum }_{i = 1}^{n} {\tilde{A}}^{{( 1 )}^{i}} {\sum }^{( i )} {A}^{{( 1 )}^{{i}^{T}}} ‖$$

In a subsequent step 312, first time series 208 is mapped using third model 212′ on a second prediction 216 at the first temporal resolution.

In the example, second prediction 216 of layer 1 is:

ŷ_{1:T}⁽¹⁾=(ŷ₁⁽¹⁾, . . . , ŷ_{T}⁽¹⁾)

In a subsequent step 314, input variable 202 for first model 204 is determined. Input variable 202 includes at least a part of first time series 208 and at least a part of second prediction 216. In the example of model 200, two layers are provided. If more than two layers are provided, steps 304 through 312 are carried out repeatedly for the L layers of the multilayer state space model beginning at layer 1.

For layer l, layers 1, . . . l−1 are already taught.

The prediction of layer l−1 is

ŷ_{1:T}⁽¹⁾=(ŷ₁⁽¹⁾, . . . , ŷ_{T}⁽¹⁾)

The prediction of layer l−1 is added to the time series for layer l:

u_{1:T[n}_{₁}_{]}⁽¹⁾=(u₁,u₁₊ₙₗ, . . . , u_{T-nl},u_{T};y₁^{(l-1)}, . . . , y_{T}^{(l-1)})

The prediction of layer l−1 contains the pieces of information of all prior layers. This means input variable 202 is determined as a function of the second prediction of layers 1, . . . , L−1.

In a subsequent step 316, the parameters of first model 204 are determined using input variable 202.

The parameters of first model 204 are determined, for example, in a training of first model 204 using training data which include input variable 202 and a reference for variable 206 at the first temporal resolution.

In a subsequent step 318, input variable 202 is mapped using first model 204 on variable 206.

For the prediction, input variable 202 is determined in the example using a prediction which is determined using the upscaled linear transition model of layer 1 on data D:

ŷ_{1:T}⁽¹⁾=(ŷ₁⁽¹⁾, . . . , ŷ_{T}⁽¹⁾)

If more than two layers are provided, data D are mapped by the particular upscaled linear transition model of the individual L layers on predictions from which input variable 202 is determined. Data D in the first temporal resolution are used for the layers.

Optionally, in a subsequent step 320 for a time series which represents the operating variable of technical system 102 in the first temporal resolution, for each upscaled linear transition model of the individual L layers, its input variable is determined and mapped on its prediction and thus variable 206 is determined for this time series.

Subsequently, in a step 322, it is checked whether variable 206 meets a condition or not. If variable 206 meets the condition, a step 324 is carried out. Otherwise, a step 326.

The condition is met in the example when an anomaly is recognized.

In step 324, technical system 102 is switched into a safe operating state, for example, switched off.

Subsequently, step 320 is carried out.

In step 326, technical system 102 is switched into an intended operating state, for example, switched on. If technical system 102 is already running in the normal operating state, this is maintained unchanged in step 326. “Intended” in this example means that technical system 102 may carry out its function without restrictions.

The condition is met in the example when the variable indicates that the operating variable is outside a permitted range. Model 200 may be trained for regression of variable 206, the condition being met when variable 206 is outside a range of permitted variables. Model 200 may be trained for classification, the condition being met when the variable represents a predefined class.

Subsequently, step 320 is carried out.

What is claimed is:

1. A computer-implemented method for determining a variable of a technical system, the technical system being a fuel cell or an internal combustion engine, the method comprising the following steps:
determining an input variable for a first model for determining the variable of the technical system at a first temporal resolution, by:
providing a first time series at the first temporal resolution, the first time series including values which characterize an operating variable of the technical system,
providing a second time series at a second temporal resolution, the second time series including values which characterize the operating variable of the technical system, the first temporal resolution being different from the second temporal resolution,
mapping the second time series being mapped using a second model to determine a first prediction for the variable of the technical system at the second temporal resolution on the first prediction,
determining parameters of a second model using the second time series,
mapping the parameters of the second model on parameters of a third model at the first temporal resolution, and
mapping the first time series using the third model on a second prediction at the first temporal resolution, the input variable fo the first model including at least a part of the first time series and at least a part of the second prediction;
determining parameters of the first model using the input variable for the first model; and
mapping the input variable using the first model on the variable of the technical system.

2. The method as recited in claim 1, wherein the technical system is the internal combustion engine, (i) the operating variable characterizing a velocity or a load of the internal combustion engine, and/or (ii) the variable of the technical system characterizing a hydrocarbon emission of the internal combustion engine, or a nitrogen oxide emission of the internal combustion engine, or a temperature of the internal combustion engine, or a particle emission of the internal combustion engine, or an oxygen content of the internal combustion engine.

3. The method as recited in claim 1, wherein the technical system is the fuel cell, (i) the operating variable characterizing a current in a fuel cell stack of the fuel cell, or a hydrogen concentration in the fuel cell, or a stoichiometry of an anode of the fuel cell, or a stoichiometry of a cathode or the fuel cell, or a coolant volume flow of the fuel cells, or an anode pressure of the fuel cell, or a cathode pressure of the fuel cell, or a temperature of the coolant inflow of the fuel cell, or a temperature of the anode dewpoint of the fuel cell, or a temperature of a cathode dewpoint of the fuel cell, and/or (ii) the variable of the technical system characterizing an average cell voltage of the fuel cell, or an anode pressure drop of the fuel cell, or a cathode pressure drop of the fuel cell, or a coolant pressure drop of the fuel cell, or an increase of a coolant temperature of the fuel cell.

4. The method as recited in claim 1, wherein the second time series includes values from the first time series, which are taken from the first time series at the second resolution.

5. The method as recited in claim 1, wherein the second time series includes values of a third prediction for the variable of the technical system, the third prediction being determined using a fourth model as a function of a third time series, which includes values of the operating variable in a third resolution, which is different from the first resolution and the second resolution.

6. The method as recited in claim 1, wherein: (i) the parameters of the second model are determined in a training of the second model using training data which include the second time series and a reference for the first prediction at the second temporal resolution, and/or (ii) the parameters of the first model are determined in a training of the first model using training data which include the input variable and a reference for the variable of the technical system at the first temporal resolution.

7. The method as recited in claim 1, wherein the third model includes a first linear transition model, in which a first matrix for mapping a state variable of the first linear transition model is determined by at least a part of the parameters of the third model, the second model includes a second linear transition model, in which a first matrix for mapping a state variable of the second linear transition model is determined by at least a part of the parameters of the second model, the first matrix of the first transition model being determined as a function of a root of the first matrix of the second transition model, an order of the root being determined as a function of a ratio of the first resolution to the second resolution.

8. The method as recited in claim 7, wherein the first linear transition model includes a second matrix for mapping the first time series, the second matrix being determined by at least a part of the parameters of the third model, the second linear transition model including a second matrix for mapping the second time series, the second matrix being determined by at least a part of the parameters of the second model, the second matrix of the first transition model being determined as a function of a product of an inverse of a sum of a number of summands with the second matrix of the second transition model, the sum including per summand a power of the first matrix of the first transition model, the number of summands being determined as a function of a ratio of the first resolution to the second resolution, the powers of order different from one another being from a set of integer numbers from 1 to the number.

9. The method as recited in claim 7, wherein the third model includes an additive disturbance variable for the state variable of the first linear transition model, the disturbance variable of the third model being determined by a covariance matrix of a Gaussian distribution, the second model including an additive disturbance variable for the state variable of the second linear transition model, the disturbance variable of the second model being determined by a covariance matrix of a Gaussian distribution, the covariance matrix of the third model being determined so that a distance between the covariance matrix of the second model and a sum of a number of summands is minimal, the sum including per summand a product of a power of the first matrix of the third model with the covariance matrix of the third model and with a transpose of the power of the first matrix, the number of summands being determined as a function of a ratio of the first resolution to the second resolution, the powers of order different from one another being from a set of integer numbers from 1 to the number.

10. The method as recited in claim 1, wherein for a time series which represents the operating variable of the technical system in the first temporal resolution, the variable of the technical system is determined, when the variable of the technical system meets a condition: (i) an anomaly being recognized and/or the technical system being switched into a safe operating state, or (ii) the technical system otherwise being switched into an intended operating state.

11. A device for determining a variable of a technical system, comprising:
a computing unit configured to:
determine an input variable for a first model for determining the variable of the technical system at a first temporal resolution, by:
providing a first time series at the first temporal resolution, the first time series including values which characterize an operating variable of the technical system,
providing a second time series at a second temporal resolution, the second time series including values which characterize the operating variable of the technical system, the first temporal resolution being different from the second temporal resolution,
mapping the second time series being mapped using a second model to determine a first prediction for the variable of the technical system at the second temporal resolution on the first prediction,
determining parameters of a second model using the second time series,
mapping the parameters of the second model on parameters of a third model at the first temporal resolution, and
mapping the first time series using the third model on a second prediction at the first temporal resolution, the input variable fo the first model including at least a part of the first time series and at least a part of the second prediction;
determining parameters of the first model using the input variable for the first model; and
mapping the input variable using the first model on the variable of the technical system.

12. The device as recited in claim 11, wherein the technical system is a fuel cell or an internal combustion engine.

13. A non-transitory computer-readable storage medium on which is stored a computer program including computer-readable instructions for determining a variable of a technical system, the technical system being a fuel cell or an internal combustion engine, the instructions, when executed by a computer, causing the computer to perform the following steps:
determining an input variable for a first model for determining the variable of the technical system at a first temporal resolution, by:
providing a first time series at the first temporal resolution, the first time series including values which characterize an operating variable of the technical system,
providing a second time series at a second temporal resolution, the second time series including values which characterize the operating variable of the technical system, the first temporal resolution being different from the second temporal resolution,
mapping the second time series being mapped using a second model to determine a first prediction for the variable of the technical system at the second temporal resolution on the first prediction,
determining parameters of a second model using the second time series,
mapping the parameters of the second model on parameters of a third model at the first temporal resolution, and
mapping the first time series using the third model on a second prediction at the first temporal resolution, the input variable fo the first model including at least a part of the first time series and at least a part of the second prediction;
determining parameters of the first model using the input variable for the first model; and
mapping the input variable using the first model on the variable of the technical system.
